(19) United States
(12) Patent Application Publication
(10) Pub. No.: US 2018/0020002 A1
(43) Pub. Date: Jan. 18, 2018

(54) SYSTEM AND METHOD FOR FILTERING INTERNET TRAFFIC AND OPTIMIZING SAME

(71) Applicants: Frederick J Duca, Marshall, VA (US); Alexander Gabriel Chamandy, Arlington, VA (US)

(72) Inventors: Frederick J Duca, Marshall, VA (US); Alexander Gabriel Chamandy, Arlington, VA (US)

(21) Appl. No.: 15/208,766

(22) Filed: Jul. 13, 2016

(51) Int. Cl. H04L 29/06; G06F 21/57

(52) U.S. Cl. CPC H04L 63/101; H04L 63/0281; G06F 21/575; H04L 63/0236; G06F 21/572; H04L 63/107; H04L 63/1441; G06F 2221/2111; G06F 2221/2141; H04L 63/1458; H04L 2463/142; H04L 2463/144

(57) ABSTRACT

A method for filtering internet traffic between one or more users and the internet is described herein, the method iterated in a computer system having a processor and an operating system software implemented by the processor and representative of executable code. In the method, website requests are received from one or more client devices of the one or more users, and the requests are compared against one of an internal whitelist of websites built and maintained by one or more external servers on behalf of a consumer organization, and a master whitelist approved and managed by the organization. If the website is on the whitelist, the one or more external servers grant access to the internet traffic so that the client device receives the website URL and content thereof, otherwise access to the requested website is blocked.

### CROSS-REFERENCE TO RELATED APPLICATION

The present application is related to U.S. Pat. No. 9,092,596 to Frederick J. Duca, issued Jul. 28, 2015, the entire contents of which is hereby incorporated by reference herein and hereafter referred to as the “596 patent”.

### BACKGROUND

### Field

Example embodiments in general relate to a computer system and a computer-implemented method for filtering internet traffic, and for optimizing the filtered internet traffic.

### Related Art

The internet has become a dominating source of obtaining information and media for many individuals. Unfortunately, the internet is also utilized by pornographers and individuals with ill or malicious intent to provide illicit and pornographic materials. In some cases, the ease of obtaining pornographic and illicit materials on the internet has resulted in individuals, who would not otherwise be involved with such illicit or pornographic materials, becoming more interested or even addicted to the illicit or pornographic materials. These addictions are not just limited to pornographic content, but can apply to any questionable or potentially-deleterious content, such as that related to gambling for example.

Additionally, malicious sources such as botnets can adversely affect the web traffic viewed by private individuals and organizations. Web traffic is the amount of data sent and received by visitors to a web site. This necessarily does not include the traffic generated by bots, which are autonomous software that operates as an agent for a user or a program or simulates a human activity, also known as spiders or crawlers that are used for searching. In general, websites monitor the incoming and outgoing traffic to see which parts or pages of their site are popular and if there are any apparent trends, such as one specific page being viewed mostly by people in a particular country. There are many ways to monitor this traffic and the gathered data is used to help structure sites, highlight security problems or indicate a potential lack of bandwidth.

Not all web traffic is welcomed. Some companies offer advertising schemes that, in return for increased web traffic (visitors), pay for screen space on the site. Sites also often aim to increase their web traffic through inclusion on search engines and through search engine optimization. Web traffic can be increased by placement of a site in search engines and purchase of advertising, including bulk e-mail, pop-up ads, images and videos related to the ads, and other in-page advertisements. Web traffic can also be increased by purchasing through web traffic providers or non-internet based advertising. Web traffic can further be increased not only by attracting more visitors to a site, but also by encouraging individual visitors to “linger” on the site, viewing many pages in a visit. (See OUTBRAIN® for an example of this practice).

For many private users and organizations, the aforementioned bulk e-mail advertising, pop-up ads, videos/images, in-page advertisements and OUTBRAIN-type links are typically undesirable, and often can severely slow the speed at which the page is downloaded and viewed. Sometimes, the advertising may be a front for a malicious source purposefully generating malicious content, as an attempt to make a denial-of-service (DoS) attack.

In computing, DoS is an attempt to make a machine or network resource unavailable to its intended users, such as to temporarily or indefinitely interrupt or suspend services of a host connected to the Internet. A distributed denial-of-service (DDoS) is where the attack source is more than one—and often thousands of—unique IP addresses. Criminal perpetrators of DoS attacks often target sites or services hosted on high-profile web servers such as banks, credit card payment gateways, for example.

The differences between DoS and DDoS are substantive. In a DoS attack, a perpetrator uses a single Internet connection to either exploit a software vulnerability or flood a target with fake requests—usually in an attempt to exhaust server resources (e.g., RAM and CPU). Conversely, DDoS attacks are launched from multiple connected devices that are distributed across the Internet. These multi-person, multi-device barrages are generally harder to deflect, mostly due to the sheer volume of devices involved. Unlike single-source DoS attacks, DDoS assaults tend to target the network infrastructure in an attempt to saturate it with huge volumes of traffic. DDoS attacks also differ in the manner of their execution. Broadly speaking, DoS attacks are launched using homebrewed scripts or DoS tools (e.g., Low Orbit Ion Canon), while DDoS attacks are launched from botnets—large clusters of connected devices (e.g., cellphones, PCs or routers) infected with malware that allows remote control by an attacker.

Defensive responses to DoS/DDoS attacks typically involve the use of a combination of attack detection, traffic classification and response tools, aiming to block traffic that they identify as illegitimate and allow traffic that they identify as legitimate. These prevention tools include but are not limited to firewalls, switches, routers, application front-end hardware (intelligent hardware placed on the network before traffic reaches the servers), application level Key Completion Indicators to meet the case of application level DDoS attacks against Cloud based applications, Intrusion-prevention systems (IPS), and the like.

Additionally, some organizations employ a DoS Defense System (DDS) to block connection-based DoS attacks and those with legitimate content but bad intent. A DDS can also address both protocol attacks (such as Teardrop and Ping of death) and rate-based attacks (such as ICMP floods and SYN floods). Others may employ “Blackholing and Sinkholing”. With blackholing, all the traffic to the attacked Domain Name Service (DNS) address or IP address is sent to a “black hole” (null interface or a non-existent server), and is managed by the ISP. Sinkholing routes traffic to a valid IP address which analyzes traffic and rejects bad packets; but is ineffective for most severe attacks (DDoS attacks).

In an attempt to prevent or limit access to this illicit and potentially-deleterious content, and as internet use rose, debate over objectionable content online sparked the introduction of internet filters offered by third-party mitigation service providers. Such filters, employing a process of upstream filtering, restrict access to video, images and Web pages based on rules established by parents, schools and/or organizations. Internet filters are now widely available, integrated into popular Web browsers such as MICROSOFT®'s INTERNET EXPLORER® and the freely available FIREFOX®. More elaborate Internet filtering is available for consumer purchase as a licensed download as separate applications, such as NETNANNY® by the third-party mitigation service provider CONTENTWATCH® Inc. out of Salt Lake City, Utah.

In an upstream filter, all traffic is passed through a “scrubbing center” via proxy servers, tunnels, direct circuits and the like to separate out the prohibited or “bad” traffic (DDoS and other common Internet attacks) and only send allowable or “good” traffic to the server. Other third-party mitigation service providers who offer this type of upstream filtering include RADWARE®, AT&T®, F5 NETWORKS®, INCAPSULA®, and PROLEXIC TECHNOLOGIES®, to name of few.

Thus, Internet filters have a variety of uses—from protecting children, limiting public access to certain sites or material, to restricting when and how employees of an organization can use the Internet while at work. Internet filters work by excluding or including content. These methods are more commonly referred to as a “blacklist” or “whitelist.” As its name implies, a blacklist blocks all websites or material restricted by an authority. The reverse, a whitelist, generally bars access to all Internet content except items approved by the filter.

According to WIKIPEDIA®, a whitelist is a list or register of entities that are being provided a particular privilege, service, mobility, access or recognition. Entities on the list will be accepted, approved and/or recognized. Whitelisting is the reverse of blacklisting, the practice of identifying entities that are denied, unrecognized, or ostracized. There are numerous types of whitelists, including but not limited to e-mail, non-commercial, commercial, local area network (LAN)/wide area network (WAN), program, and application whitelists.

According to John Stauffacher, a world-renowned expert in web application security and the author of the to-be-released book entitled “Web Application Firewalls: A Practical Approach” by SYNGRESS® Media, Inc. in October, 2017, it is now readily apparent that the best approach to web application security is to whitelist the “good” web traffic in an application rather than to blacklist the “bad”. This is because it is simpler to enumerate all that is good within an application than it would be to continually update all of the bad that could possibly be thrown at the application. A whitelisting approach is far more secure and efficient than continuously enumerating the bad in one's web traffic, as bad web traffic changes daily. Web teams that rely on blacklisting often end up spending inordinate time and resources chasing the latest zero-day threat and listing every attack vector, writing and updating rules in their Web Application Firewall (WAF), etc., to the point that their WAF becomes a list of attack signatures that looks into the past and fails to stop new threats.

Stauffacher further notes that while the initial process of establishing a whitelist requires a bit more upfront time than blacklisting, the developer, security officer, client, and/or organization may gain a more proactive and robust WAF security stance that doesn't have to play catch-up with every zero-day threat that comes down the pike.

As to e-mail whitelists, spam filters that come with e-mail clients have both whitelists and blacklists of senders and keywords to look for in e-mails. If a spam filter keeps a whitelist, mail from the listed e-mail addresses, domains, and/or IP address will always be allowed. Additionally, some internet service providers have whitelists that they use to filter e-mail to be delivered to their customers.

If a whitelist is exclusive, only e-mail from entities on the whitelist will get through. If it is not exclusive, it prevents e-mail from being deleted or sent to the junk mail folder by the spam filter. Usually, only end-users would set a spam filter to delete all emails from sources not on the whitelist, not internet service providers (ISPs) or e-mail services.

Using whitelists and blacklists can assist in blocking unwanted messages and allowing wanted messages to get through, but they are imperfect. E-mail whitelists are used to reduce the incidence of false positives, often based on an assumption that most legitimate mail will be from a relatively small and fixed set of senders. To block a high percentage of spam, e-mail filters have to be continuously updated as e-mail spam senders create new e-mail addresses to e-mail from or new keywords to use in their e-mail which allows the e-mail to slip through. As an example, Amazon.com uses whitelists to limit access to its KINDLE® e-reader devices. Besides AMAZON® itself, only e-mail addresses whitelisted by the device's registered owner can send content (“personal documents”) to that device.

Non-commercial whitelists are typically operated by various non-profit organizations, ISPs and others interested in blocking spam. Rather than paying fees the sender must pass a series of tests; for example, his email server must not be an open relay and have a Static IP address. The operator of the whitelist may remove a server from the list if complaints are received.

Commercial whitelists comprise a system by which an ISP allows someone to bypass spam filters when sending e-mail messages to its subscribers, in return for a pre-paid fee, either an annual or a per-message fee. A sender can then be more confident that his messages have reached their recipients without being blocked, or having links or images stripped out of them, by spam filters. The purpose of commercial whitelists is to allow companies to reliably reach their customers by e-mail. Example commercial providers include Return Path Certification, ECO's™ CERTIFIED SENDERS ALLIANCE™ (CSA), and the Spamhaus Whitelist managed by The Spamhaus Whitelist Company, Ltd.

One of the most well-publicized and controversial commercial whitelists services was known as CERTIFIEDEMAIL™ by GOODMAIL SYSTEMS®, which first made headlines in February 2006 when AOL® and YAHOO® announced plans to implement it, and to charge senders on a per message basis. The messages were clearly identified to the user as having come from a trusted source, and paying senders had to pass a system of accreditation with GOODMAIL, whereby their messages were only sent to people who had a pre-existing business relationship with the sender. If a sender sent a message to a user who had not previously agreed to receive it, AOL would entirely block the sender.

However, this practice was heavily protested as an “email tax”, and claims were made that AOL was giving spammers a direct route into users' mailboxes, while attempting to move more people to paid e-mail by causing a larger amount of legitimate unpaid email to be rejected by the spam filters. Before GOODMAIL's shutdown in February 2011, CERTIFIEDEMAIL had been adopted by seven of the top 10 ISPs in the USA at that time: AOL, AT&T®, COMCAST®, COX®, ROAD RUNNER®, VERIZON®, and YAHOO.

A further use for whitelists is in WAN/LAN security. Many network admins set up MAC address whitelists, or a MAC address filter, to control who is allowed on their networks. This is used when encryption is not a practical solution or in tandem with encryption. However, it can be often ineffective because a MAC address can be faked. Some firewalls can be configured to only allow data-traffic from/to certain (ranges of) IP-addresses.

As to a program whitelist, if an organization keeps one of software, only titles on the list will be accepted for use. The benefits of whitelisting in this instance are that the organization can ensure itself that users will not be able to download and/or use programs that have not been deemed appropriate for use. Moreover, an emerging approach in combating viruses and malware is to whitelist that software deemed safe to run, blocking all others. The approach of employing an application whitelist in an operating system (OS) was first implemented by the American computer scientist Dr. John Harrison. Example well-known providers of application whitelisting technology include ARELLIA®, BIT9®, MCAFEE®, and LUMENSION®. These products may provide administrative control over program whitelists in addition to preventing introduction of new malware.

For Unix OS variants, HEWLETT-PACKARD ENTERPRISE® has developed HP-UX Whitelisting (WLI). WLI offers file and system resource protection based on RSA encryption technology on HP Integrity servers running HP-UX 11iv3. WLI is complementary to the traditional UNIX discretionary access controls (DAC) based on user, group, and file permissions. The more granular DAC access control list (ACL) permissions available on aVeritas journaled File System (VxFS) and/or a High Performance File System (HFS) are likewise not affected. The HFS is the legacy file system used with HP-UX, and still remains in use for the/stand file system and is supported on all HP-UX releases. The first 8 Kbytes of all HFS file systems contain the HFS superblock, which contains general information and pointers to the metadata area. HFS contains more than one copy of the superblock, and the locations of these redundant copies are recorded in the /var/adm/sbtab file. If the main superblock is damaged, it can be recovered from one of the backup copies.

JFS is the HP-UX version of the VxFS, is now used in all newer versions of HP-UX, and exhibits fast recovery features. Like HFS, JFS also maintains multiple copies of the superblock, but these are not stored in any file. JFS keeps a record of these copies automatically. JFS keeps a record of all transactions to the file system metadata area in an intent log. The intent log is used for system recovery in case of a system crash. If a file system update is completed successfully, a “done record” is written to the intent log showing that this update request was successful.

In case of a system crash, the intent log is consulted and the file system is brought to a stable state by removing all unsuccessful transactions with the help of the intent log. Another big advantage of JFS over HFS is that it creates inodes dynamically. An inode is a data structure used to represent a filesystem object, which can be one of various things including a file or a directory. Each inode stores the attributes and disk block location(s) of the filesystem object's data. So if the inode table is full but there is still space on the file system, JFS can create new inodes automatically.

For any of these types of whitelists, a web proxy server is typically employed, also commonly referred to in computing as any of a proxy, proxy server, web proxy or proxy site. A proxy web server is a server that sits between a client application, such as a Web browser, and a real server. The proxy server may exist in the same machine as a firewall server or it may be on a separate server, which forwards requests through the firewall. The proxy server intercepts all requests to the real server to see if it can fulfill the requests itself. If not, it forwards the request to the real server.

An advantage of a proxy server is that its cache can serve all users. As is well known, the server's cache is the random access memory (RAM) that the server's microprocessor/CPU can access more quickly than it can access regular RAM. This cache typically is integrated on the server's CPU chip or on a separate chip with bus interconnect to the CPU. If one or more Internet sites are frequently requested, these are likely to be in the proxy's cache, which will improve user response time. A proxy can also log its interactions, which can be helpful for troubleshooting.

Proxy servers have two primary purposes: to improve performance and to filter requests. For example, proxy servers can dramatically improve performance for groups of users. This is because it saves the results of all requests for a certain amount of time. Consider the case where both user X and user Y access the World Wide Web (www) through a proxy server. First user X requests a certain web page, which we'll call “Page 1”. Sometime later, user Y requests the same page. Instead of forwarding the request to the web server where Page 1 resides, which can be a time-consuming operation, the proxy server simply returns the Page 1 that it already fetched for user X. Since the proxy server is often on the same network as the user, this is a much faster operation. Real proxy servers are designed to support hundreds or thousands of users.

Proxy servers can also be used to filter requests. For example, a company might use a proxy server to prevent its employees from accessing a specific set of websites, which ties into iterating a whitelisting application directly on the proxy or on a client through the proxy to the real server, such as an application server for example.

A well-known open-source web proxy server that is publically available is known as SQUID, Ver. 3.5.12 (Nov. 27, 2015). Many individuals use SQUID without even knowing it, as their operating systems include SQUID in their ports/packages system. Some companies have embedded SQUID in their home or office firewall devices, whereas others use SQUID in large-scale web proxy installations to speed up broadband and dialup internet access. Squid is being increasingly used in content delivery architectures to deliver static and streaming video/audio to internet users worldwide.

A caching and forwarding web proxy, the SQUID web proxy has a wide variety of uses, from speeding up a web server by caching repeated requests, or caching web, DNS and other computer network lookups for a group of people sharing network resources, or aiding security by filtering traffic. Although primarily used for HTTP and FTP, Squid includes limited support for several other protocols including TLS, SSL, Internet Gopher and HTTPS.

In operation, when a proxy server receives a request for an Internet resource (such as a web page), it looks in its local cache of previously pages. If it finds the page, it returns it to the user without needing to forward the request to the Internet. If the page is not in the cache, the proxy server, acting as a client on behalf of the user, uses one of its own IP addresses to request the page from the server out on the Internet. When the page is returned, the proxy server relates it to the original request and forwards it on to the user.

Proxy servers are used for both legal and illegal purposes. In the enterprise, a proxy server is used to facilitate security, administrative control or caching services, among other purposes. In a personal computing context, proxy servers are used to enable user privacy and anonymous surfing. Proxy servers can also be used for the opposite purpose: To monitor traffic and undermine user privacy. To the user, the proxy server is invisible; all Internet requests and returned responses appear to be directly with the addressed Internet server. (The proxy is not actually invisible; its IP address has to be specified as a configuration option to the browser or other protocol program.)

In general, setting up a simple, small proxy server for whitelisting selected traffic or content is now fairly easy to accomplish for the application developer. For example, one publically-known and available approach for setting up a small HTTP-only proxy web server is to build a filter file in which the developer initially installs and configures a free proxy application such as “tinyproxy”. This is a HTTP proxy server daemon for POSIX operating systems that is designed to be fast and small. Tinyproxy is useful when an HTTP/HTTPS proxy is required, but where the system resources for a larger proxy are unavailable.

Then, parameters for the IP addresses used by the proxy server to accept connections and connect to the internet are altered, such as “MinSpareServers, MaxSpareServers, and StartServers”. These represent the minimum and maximum number of threads started by the proxy server, whereby each thread handles one request at the same time. Startservers handles the number of threads started by the proxy without any requests.

Next, the IP address of clients (such as smart phones, PCs, LANs, etc.) that are allowed to use the proxy server are input, the allowable SSL connections are added (e.g., such as “ConnectPort 443, ConnectPort 563”. At the end of the filter file, the following lines of code may be added to enable whitelisting:
FilterExtended On,
FilterURLs On,
FilterDefaultDeny Yes, and
Filter “/etc/tinyproxy/whitelist”.
   Accordingly, now all requests will be denied except the ones defined in the filter file. Thereafter, the domains desired too be allowed are added to build the whitelist, i.e. “nano/etc/tinyproxy-whitelist.conf”, with content like twitter.com, cnn.com, espn.com, etc.

However, even given the above example web proxy server iteration and configuration for filtering web traffic, certain private individuals or employees of organizations who may be a porn or gambling addict, or even merely a voyeur of such “bad” content, may try to bypass such a filter or other content blocking software that is installed on a computing device such as their smart phone, PC or laptop. This is especially true where selected ones of these individuals have advanced computing skills enabling them to attempt to devise ways in order to disable, uninstall, or to circumvent the blocking/filtering functionality on their computing devices. Additionally, younger generations of computer users typically exhibit a greater understanding of the operating system troubleshooting tools and also may be able to bypass or disable selected settings in the downloaded filtering application in order to circumvent selected settings thereof set by their parents, in order to view prohibited content on the internet. Even the most robust upstream filtering solutions are not immune to compromise by an end-user.

### SUMMARY

An example embodiment of the present invention is directed to a computer system configured to filter internet traffic between one or more users and the internet. The system includes a file configured for installation on one or more corresponding client computing devices of the one or more users, and one or more remote proxy servers in operative communication with the file and the internet. The one or more proxy servers are configured to analyze website requests from the client devices against one of an internal whitelist of websites built and maintained by the proxy servers on behalf of a consumer organization, and a master whitelist approved and managed by the organization. If a website query is determined to be on the whitelist, the one or more proxy servers pass the approved internet traffic to the internet so that the client device receives the website URL and content thereof corresponding to the internet traffic, otherwise the request is blocked and access denied.

Another example embodiment is directed to a method for filtering internet traffic between one or more users and the internet is described herein, the method iterated in a computer system having a processor and an operating system software implemented by the processor and representative of executable code. In the method, website requests are received from one or more client devices of the one or more users, and the requests are compared against one of an internal whitelist of websites built and maintained by one or more external servers on behalf of a consumer organization, and a master whitelist approved and managed by the organization. If the website is on the whitelist, the one or more external servers grant access to the internet traffic so that the client device receives the website URL and content thereof, otherwise access to the requested website is blocked.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 is an illustration of exemplary communications between application servers and clients in an effort to describe the filter system consistent with the example embodiments.

FIG. 2 is a flow diagram to illustrate a computer-implemented method of filtering and optimizing internet traffic of a client, consistent with the disclosed embodiments.

### DETAILED DESCRIPTION

As will be appreciated by one skilled in the art, the example embodiments of the present invention may be embodied as a system, method, set of machine readable instructions and associated data in a manner more persistent than a signal in transit, or computer program product. Accordingly, aspects of the example embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the example embodiments may take the form of a computer program product embodied in one or more computer-readable medium(s) having computer readable program code/instructions embodied thereon.

As used herein, the phrase “present invention” should not be taken as an absolute indication that the subject matter described by the phrase is covered by either the claims as filed, or by the claims that may eventually issue after patent prosecution. While the phrase “present invention” is used to help the reader attain a general feel for which disclosures herein are believed as being novel, this understanding, as indicated by use of the “present invention,” is tentative, provisional and subject to change over the course of patent prosecution as relevant information is developed and as the claims are potentially amended. Additionally, and unless the context requires otherwise, throughout the specification and claims that follow, the word “comprise” and variations thereof, such as “comprises” and “comprising,” are to be construed in an open, inclusive sense, that is, as “including, but not limited to.”

As used herein, the terms “program” or “software” are employed in a generic sense to refer to any type of computer code or set of computer-executable instructions that can be employed to program a computer or other processor to implement various aspects of the present invention as discussed above. Additionally, it should be appreciated that one or more computer programs that when executed perform methods of the example embodiments need not reside on a single computer or processor, but may be distributed in a modular fashion amongst a number of different computers or processors to implement various aspects of the example embodiments.

Computer-executable instructions may be in many forms, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Additionally, a “computing device” as used hereafter (and occasionally referred to hereafter as a “client computing device” or “client device”) encompasses any of a smart device, a firewall, a router, and a network such as a LAN/WAN. As used herein, a “smart device” is an electronic device, generally connected to other devices or networks via different wireless protocols such as Bluetooth, NFC, WiFi, 3G, 4G, etc., that can operate to some extent interactively and autonomously. Smart devices include but are not limited to smartphones, PCs, laptops, phablets and tablets, smartwatches, smart bands and smart key chains. A smart device can also refer to a ubiquitous computing device that exhibits some properties of ubiquitous computing including—although not necessarily—artificial intelligence. Smart devices can be designed to support a variety of form factors, a range of properties pertaining to ubiquitous computing and to be used in three primary system environments: physical world, human-centered environments, and distributed computing environments.

As used herein, the term “cloud” or phrase “cloud computing” means storing and accessing data and programs over the Internet instead of a computing device's hard drive. The cloud is a metaphor for the Internet.

Further, and as used herein, the term “server” is meant to include a computer system, including processing hardware, software, and process space(s), an associated storage system and optionally a database application (e.g., OODBMS or RDBMS) as is well known in the art. It should also be understood that “server system” and “server” are often used interchangeably herein. Similarly, any kind of database described herein can be implemented as single databases, a distributed database, a collection of distributed databases, a database with redundant online or offline backups or other redundancies, etc., and might include a distributed database or storage network and associated processing intelligence.

Moreover, as used herein the phrase “malicious or prohibited traffic” refers to Internet traffic that is related to any website, online application, image, video, hypertext link and text that includes any of pornography, sexually suggestive content, violent content, profane language, racism/sexism, malware or embedded malware, fraud, spam, advertising, or any other form of content that is not present on a whitelist maintained by a proxy server on behalf of an organization, parent, or other private group or individual.

Internet traffic herein is defined as the flow of all data across the Internet, and includes web traffic as a subset. Because of the distributed nature of the Internet, there is no single point of measurement for total Internet traffic. Internet traffic data from public peering points can give an indication of Internet volume and growth, but these figures exclude traffic that remains within a single service provider's network as well as traffic that crosses private peering points. Accordingly, Internet traffic is sometimes used [inaccurately] to describe web traffic, which is the amount of data sent and received by visitors of a particular web site.

In its most basic definition, and as used hereafter, the term “bandwidth” describes the level of traffic and data allowed to travel and transfer between a businesses' site, users, and the Internet. Each web hosting company typically will offer a particular level of bandwidth. This is often a good indication of which hosting companies have the best of three essential components: Networks, connections and systems. Usually, the more bandwidth a web host can provide, the faster and the better these three factors will be. The computing system(s), method(s) and computer program product(s) as described in the example embodiments may be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means or the like. In general, any device(s) or means capable of implementing the methodology illustrated herein can be used to implement the various aspects of the example embodiments.

The example computing system described hereafter can include clients and servers. A client and server are generally remote from each other and typically interact over a communication network. The relationship of client and server arises by virtue of computer programs running on the respective computers and having a client-server relationship to each other.

Exemplary hardware that can be used for the example embodiments includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus or device, or any suitable combination of the foregoing. A non-exhaustive list of specific examples for a computer-readable storage medium would include at least the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In the context of this Detailed Description, a computer-readable storage medium may be any tangible medium that can contain or store a program for use by or in connection with an instruction execution system, apparatus or device. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Accordingly, the present invention foresees that a non-transitory computer readable information storage media having stored thereon information, that, when executed by a processor, causes the steps described in more detail hereafter in the example method(s) to be performed.

In the context of this Detailed Description, a computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including but not limited to wireless, wireline, optical fiber cable, RF, etc., or any suitable combination of the foregoing.

The techniques described in the following example embodiments may also be implemented in a distributed computing system that includes a back-end component, e.g., as a data server, and/or a middleware component, e.g., an application server or proxy web server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

Computer program code for carrying out operations for aspects or embodiments of the present invention may be written in any combination of one or more programming languages, including an object oriented programming language such as JAVA®, SQL™ PHP™, RUBY™, PYTHON®, JSON, HTML5™, OBJECTIVE-C®, SWIFT™, XCODE®, SMALLTALK™, C++ or the like, conventional procedural programming languages, such as the “C” programming language or similar programming languages, any other markup language, any other scripting language, such as VBScript, and many other programming languages as are well known may be used.

The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet using an Internet Service Provider).

Method or function steps of the embodiments described herein can be performed by one or more programmable processors executing a computer program or program code to perform functions of the invention by operating on input data and generating output. Method or function steps can also be performed by, and system and/or apparatus of the invention can be implemented as, special purpose logic circuitry, e.g., an FPGA (field programmable gate array) or an ASIC (application-specific integrated circuit). Modules may refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, some described embodiments could be implemented on a computer having a display device, e.g., a CRT (cathode ray tube) LED (light emitting diode), or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Example embodiments and aspects of the present invention are described below with reference to flowchart illustrations and/or block diagrams of methods, apparatus (systems) and computer program products according to embodiments of the invention. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise. As used in the specification and appended claims, the terms “correspond,” “corresponds,” and “corresponding” are intended to describe a ratio of or a similarity between referenced objects. The use of “correspond” or one of its forms should not be construed to mean the exact shape or size. Further, and in the drawings, identical reference numbers identify similar elements or acts. The size and relative positions of elements in the drawings are not necessarily drawn to scale.

As to be set forth more fully below, the example embodiments in general are directed to a computer-implemented filtering method and computer system configured to monitor and control internet traffic accessible by one or more users through the use of one or more whitelists. The users in an example may be embodied as an employee of an organization or children of a parent, each having access to the Internet through a computing device. In another example, the user might be a malicious user or hacker attempting to pass bad traffic to the authorized users (e.g., employees or children of the purchasing consumer (organization or parents)). The one or more whitelists determine what the user(s) may see, with any content not matching up to a stored URL on a whitelist blocked or filtered. Thus, all internet traffic from/to these user(s) is handled by the example filter system as to be described below

The example computer system and computer-implemented method was developed by combining standard computer hardware technology and our novel filtering software. The computer system and method(s) described hereafter may be designed primarily to block malicious or prohibited traffic, including but not limited to internet traffic that is related to pornography, sexually suggestive content, violent content, profane language, racism/sexism, malware or embedded malware, fraud, spam, advertising, or any other form of content that is not present on a whitelist maintained by a proxy server on behalf of an organization, parent, or other private group or individual. Additionally, the example computer-implemented method(s) and computer system(s) herein may be adapted to block other often harmful or illicit content such as gambling and related traffic.

Generally, the filtering method and system implemented herein relies on a cloud-based interface such as one or more web proxy server(s) in operative communication between one or more client computing devices of one or more users, and real application servers of a given website on the Internet, in order to facilitate whitelisting of allowed websites. Everything on the whitelist is the only content permissible for access by a single user (employees of the organization or children of a parent) or by multiple users or network devices thereof such as a firewall or router. The filtering process occurs in real time and utilizes a comparison algorithm implemented by the web proxy server(s) as part of the filtering process. The web proxy server(s) configured to implement the filtering process thus builds and maintains an internal whitelist on behalf of an organization. This internal whitelist continually evolves but is closely vetted by the proxy server(s). The organization subscribing to or having purchased the example filtering method and system described hereafter either accepts the internal whitelist as its own, or maintains a master whitelist which is managed by its own security administrator and is also accessible by the example filter system via the web proxy server(s).

The example method and system described hereafter may be implemented so as to address all forms of Internet traffic, which is much broader than simply web traffic. The example filtering method and system to be described hereafter provides a dedicated layer of control with regard to both security and functionality of a company's or a household's flow of Internet traffic through their various computing devices.

As will be described in further detail below, the example system and method may be implemented as a purchased service, such as a subscriber-based service. Alternatively, the method/system may be installed as a “black box” on a client network server, such as in the form of a firewall, router, or a bridge.

The example filtering method and system hereafter described is expected to offer many benefits to the client (company/household). Namely, the example method and system provide the ability to filter out bad traffic not on an approved whitelist, and to render content on a whitelisted website prior to delivering the page to the client in such a way that the client's bandwidth is conserved. Additionally, the example method and system solve major security issues in the way a company or household controls its own Internet connectivity. Further, the example embodiments described herein substantially address and enhance privacy issues of the client, namely by scrubbing or removing private identity information, IP addresses, and/or information specific to their own client computing device, information that in the absence of other content blocking controls is typically publically available and hence can be tracked by large commercial data aggregators.

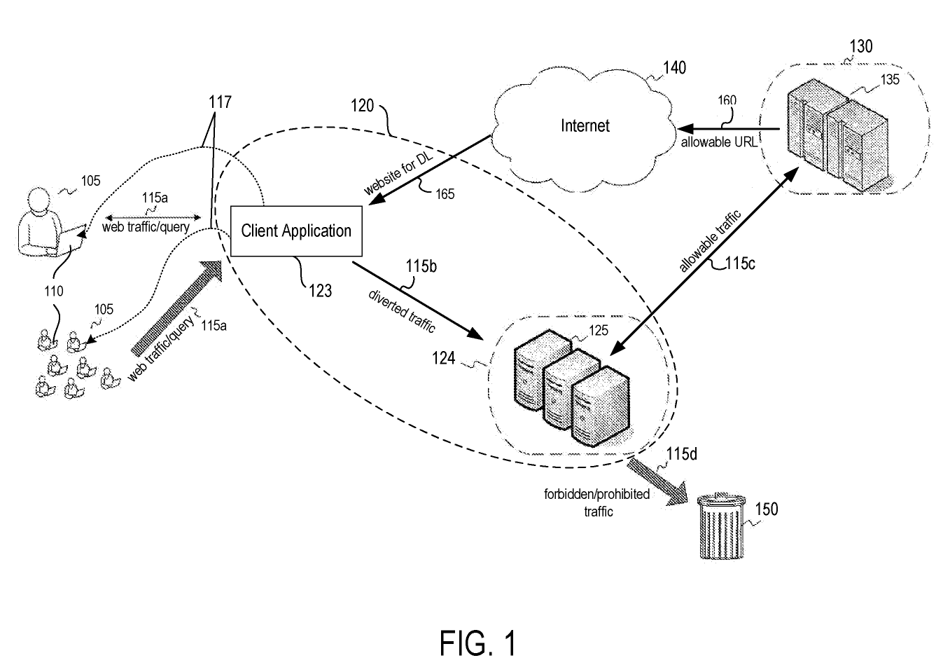

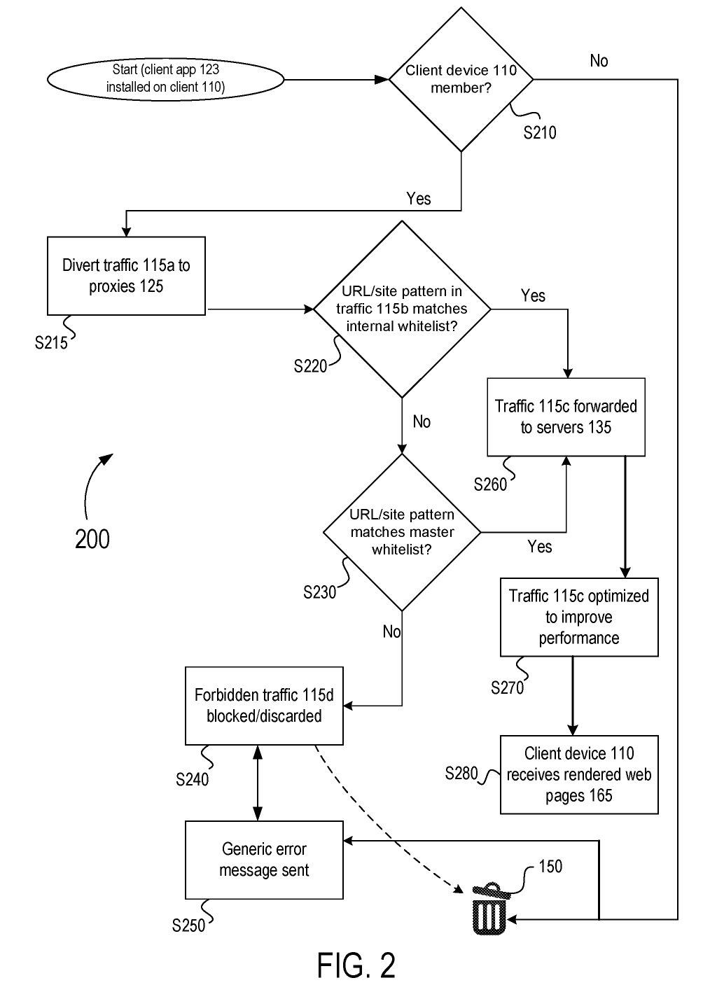

FIGS. 1 and 2 are directed to an example filter system and filtering method according to the example embodiments, and should be referred to hereafter. In general, one or a plurality of client computing device(s) 110 and the Internet 140 are not directly controlled by the consumer (company/organization/parent); as such these are areas out-of-control of the filter system 120. The whitelist(s) are direct control areas, although the client (such as a company/organization/household and the like) shall only have limited, surface control of the whitelist. This is because the whitelist is controlled and maintained remotely by the filter system 120.

Initially, internet traffic 115a originating at one or a plurality of client computing devices 110 (also referred to herein occasionally as a client device 110), is redirected to the filter system 120, which includes a file 123 and web proxy servers 125. The file 123 in one example can be embodied as a software client application 123 that is downloaded and installed on the client device 110 but controlled by the proxy servers 125. In another example, the file 123 may be embodied as a file or action(s) which initiate one or more group policy or configuration changes on client device 110, hence a configuration change file 123. In a further example, the file 123 may be embodied as a black box device 123 (such as a firewall, router, bridge, and the like) that is installed or otherwise resides on a network server (company sever for example) serving the users 105. For the purposes of explanation only, and unless otherwise noted to the contrary, file 123 hereafter shall be generally referred to as “client application 123”.

Namely traffic 115a flows through the client application 123, either directly or by virtue of having the client computing device 110's Internet configuration modified to force or divert the internet traffic 115a through the web proxy server(s) 125 of the filter system 120. The one or more web proxy server computers 125 implementing the filtering process are connected to the Internet 140, so as to collect and analyze all the diverted internet traffic 115b from the client application 123 installed on corresponding client device(s) 110.

A web proxy server is typically embodied by a combination of hardware and software. In an example, the hardware requirements of the proxy server(s) 125 may include a processor or chip processor such as an Intel® 486 or higher (RISC support also available); at least 16 MB RAM (for Intel chips) or 32 MB RAM for RISC; at least 10 MB disk space for installation; at least 100 MB+0.5 MB per client for cache space, and two (2) or more network interfaces (adapters, dial-up, etc.). In an example, the software required for a web proxy server typically may include an interface and two ISAPI components. The Internet Server Application Programming Interface (ISAPI) is an N-tier API of Internet Information Services (IIS), MICROSOFT®'s collection of WINDOWS®-based web server services. The most prominent application of IIS and ISAPI is Microsoft's web server. The web proxy server 125's ISAPI components may include an ISAPI Filter Interface, an ISAPI Filter, and an ISAPI Application. Additionally, the server software may include proxy server caching mechanisms (i.e., passive/active caching) and WINDOWS sockets (“Winsock”).

The ISAPI Filter interface is one of the components of the web proxy service. The interface provides an extension that the Web server calls whenever it receives an HTTP request. The IS API Filter is called for every request, regardless of the identity of the resource requested in the URL. An ISAPI filter can monitor, log, modify, redirect and authenticate all requests that are received by the Web server. The Web service can call an ISAPI filter DLL's entry point at various times in the processing of a request or response. The Proxy Server ISAPI filter is contained in the w3proxy.dll file. This filter examines each request to determine if the request is a standard HTTP request or not.

The ISAPI Application is the second of the two web proxy components. ISAPI applications can create dynamic HTML and integrate the web with other service applications like databases. Unlike ISAPI Filters, an ISAPI Application is invoked for a request only if the request references that specific application. An ISAPI Application does not initiate a new process for every request. The ISAPI Application is also contained in the w3proxy.dll file.

The web proxy server handles caching via passive and active caching. Passive caching is the basic mode of caching, where the proxy server interposes itself between a client and an internal or external website and then intercepts client requests. Before forwarding on the request onto the web application server, the proxy server checks to see if it can satisfy the request from its cache. Normally, in passive caching, the proxy server places a copy of retrieved objects in the cache and associates a TTL (time-to-live) with that object. During this TTL, all requests for that object are satisfied from the cache. When the TTL is expired, the next client request for that object will prompt the proxy server to retrieve a fresh copy from the web. If the disk space for the cache is too full to hold new data, the proxy server removes older objects from the cache using a formula based on age, popularity, and size.

Active caching works with passive caching to optimize the client performance by increasing the likelihood that a popular object will be available in cache, and up to date. Active caching changes the passive caching mechanism by having the Proxy Server automatically generate requests for a set of objects. The objects that are chosen are based on popularity, TTL, and server load.

The Windows Sockets API, or “Winsock”, is a technical specification defining how Windows network software should access network services, especially TCP/IP. This API is the mechanism for communication between applications running on the same computer or those running on different computers which are connected to a LAN or WAN. Winsock communication channels are represented by data structures called sockets. A socket is identified by an address and a port, for example, “131.107.2.200:80”. The Winsock specification thus defines a set of standard API's that an application uses to communicate with one or more other applications, usually across a network. The Winsock API also supports initiating an outbound connection, accepting inbound connections, sending and receiving data on those connections, and terminating a session, and also includes support for other transports such as IPX/SPX and NetBEUI. Windows Sockets supports point-to-point connection-oriented communications and point-to-point or multipoint connectionless communications when using TCP/IP.

Referring again to FIG. 1, the installed client application 123 thus diverts the internet traffic 115a. The web proxy servers 125 receive the diverted internet traffic 115b from the client application 123 (one example being a website query), and compares same against the internal and/or master whitelists utilizing a comparison algorithm iterated by the proxy server(s) 125. Forbidden or prohibited traffic 115d not on the whitelist(s) is blocked. Allowable internet traffic 115c is permitted to pass through the filter system 120, and the web proxy server(s) 125 then download a copy of the website 140 content and serve same to the client device 110.

As previously noted, it is envisioned in one example by the inventors that the client (company/organization or parent/household (“consumer”) purchases and installs the client application 123 on their employees' or children's client device(s) 110. The client device 110, in addition to being embodied as various computers (PCs, laptops, notebooks and the like) may be inclusive of smart devices, routers, firewalls, and the like. In one example, the consumer organization/parent may purchase the client application 123 either from the filter vendor's website or from an application store operated by a device vendor (such as GOOGLE® PLAYSTORE™). In another example, the client application 123 is a device such as a router, firewall, bridge and the like that resides on a network server serving the users 105 of the client.

Upon installation of the client application 123, the client computing device 110 is configured to filter the internet traffic 115a queried/requested by the user(s) 105 or forwarded thereto through the web proxy servers 125 that form part of the filter system 120. Internet traffic 115a includes but is not limited to DNS, HTTP and HTTPS protocol traffic over UDP port 53 as well as TCP ports 80 and 443 respectively. The client application 123 is configured to periodically send a heartbeat to the web proxy server(s) 125. In an example, this is a built-in feature that collects data and submits reports to the proxy server(s) 125, and may include a health report, telemetry and crash data so as to help ensure that the client application 123 remains operational. However, the filter system 120 is configured so as to analyze and store metrics in addition to the information collected above. Namely, filter system 120 is designed to analyze, store and report key metrics that may be important to the client; for example, metrics as to how their internet connections are being utilized, which users 105 have been denied access and what internet traffic was blocked, and the like.

If the client application 123 becomes defeated or is otherwise compromised, the security administrator/officer of the organization will be notified of a problem. This process is part of an internal monitoring subsystem within the filter system 120 to ensure either that the client application 123 is active, or any lapse of coverage is reported within a reasonable amount of time. If a client device 110 switches to a cellular or Bluetooth network, the client device 110 remains subject to the filter 120 such that the filter 120 will not be circumvented.

As previously noted, consumers such as organizations and/or individuals (parents) may maintain their own master whitelist. If a website (URL) being queried by the client computing device is listed either on the organization's master whitelist or the internal whitelist maintained by the proxy server(s) of the example filter system, the website is approved for download to and display on the client device, otherwise it is blocked.

In a general overview of the filtering process, any internet traffic 115 diverted by way of the client application 123 reaches the filter system 120 at one or more separate web proxy servers 125. The web proxy server 125 is adapted to analyze the diverted internet traffic 115b so as to discern website requests 115a from the client computing device 110, namely as to whether or not the requested website pattern matches the whitelist of allowed websites. DNS traffic may also be monitored and modified by the use of a customized DNS system.

The web proxy server 125 for the purposes of iterating the filtering process includes but is not limited to technologies adapted to encapsulate internet traffic. These technologies include known protocols and encapsulation methods such as VPNs, SOCKS 5 proxies, HTTP proxies, HTTPS proxies, SSL/TLS proxies, and the like. The web proxy server 125 monitors all requests or websites, allowing only the requests for whitelisted websites in order to move beyond the filtering process. In an example, the whitelist(s) may be an actively monitored and crowd-sourced list, or an internally maintained list (or both) of websites having acceptable usage criteria as defined by the organization or individual administrator.

In an example, a customized DNS system includes the ability to monitor, response to requests, and modify DNS traffic on port 53 (both UDP and TCP). These features provide a secondary enforcement mechanism for filtering internet traffic 115b by ensuring that client requests 115a for host names of websites with offensive or prohibited/forbidden content (“bad traffic 115d”) will be refused or filtered. Allowable internet traffic 115c is then routed through the web proxy server 125 to the application servers 135 of the destination website 130. Any prohibited or bad traffic 115d determined from the diverted internet traffic 115b (not on whitelist) is filtered/blocked. This includes traffic that is a web element (such as an image, web link, etc.). The prohibited traffic 115d is thus blocked, with an error indicating that the filter has not whitelisted the website. Additionally, all diverted internet traffic 115b is monitored and recorded for analysis by the filter iterated on the web proxy server 125. The analysis may be used by the web proxy server 125 to improve the efficiency and accuracy of the filter.

Referring now to FIG. 2, and in an example computer-implemented filtering method 200, a querying client computing device 110 of a user 105 (e.g., requesting a given website 130 (URL) within internet traffic 115a) is first analyzed by the filter system 120 (Step S210) to determine if the client device 110 is a member of the organization. If the determination at S210 is “No”, the process ends, and the request in internet traffic 115a for the website (URL) is denied or blocked (Step S240) and discarded (represented by element/icon 150), and a generic error message is sent (Step S250). If the determination at S210 is “Yes”, the internet traffic 115b is diverted to the proxy server(s) 125 of filter system 120 for analysis (Step S215), and thus is not passed on to the application servers 135 supporting services of the requested website 130.

A comparison algorithm implemented by the web proxy server(s) 125 analyzes the incoming diverted internet traffic 115b and looks at the filter system 120's internal whitelist that has been built, updated and maintained on behalf of the organization (Step S220). If the requested URL is not on the internal whitelist (determination at S220 is “No”), the filter system 120 then compares the diverted internet traffic 115b to a master whitelist (Step S230) maintained by the security administrator of the organization. If the traffic is not on the master whitelist (determination at S230 is “No”), the filter system 120 blocks the internet traffic (Step 240) and displays a generic error message (S250) to the user(s) 105 of the client computing device 110 indicating that the queried for website 130 is not approved for access by the client device 110, and to contact the security administrator of the organization.

Conversely, if the URL is present on the internal whitelist (determination at S220 is “Yes”), or only on the master whitelist (determination at S230 is “Yes”), the filter system 120 passes the allowable internet traffic (Step S260) on to the application server(s) 135 so that the client device can 110 download the website. Thus, as best shown in FIG. 1, the content of the approved URL is forwarded from application servers 135 in internet traffic 160 via Internet 140 for download of the internet traffic 165 (Step S280) by functionality in client application 123 on the client device 110.

However, before the requested content is delivered by application servers 135 via client app 123 for download at S280 by the client device 110, the filter system 120 iterates a sub-process to render the web pages (Step S270) in the approved internet traffic 115c that are to be ultimately delivered to the client device 110. This rendering is accomplished in a way that optimizes network performance and processing speed. Namely, the sub-process renders content (e.g., web pages) in the approved web-traffic 115c by scrubbing any and all advertisement-related images and flash videos, as most of these advertisements may have embedded malware therein.

Accordingly, once the internet traffic 115 is determined to match a URL stored on the internal or master whitelist, filter system 120 provides an additional, substantially elegant optimization sub-process that renders the webpage delivered from the application servers 135 to client device 110 free of undesirable content that may slow network performance. For example, if a client device 110 requests access to CNN.com (the URL of which happens to be on the whitelist), the client device 110 is directed to the requested CNN.com site free of advertisement images and flash videos, as most of these advertisements may have embedded malware therein.

Therefore, the performance is streamlined and processing speed of the client device 110 is optimized. Namely, the network stream of the internet traffic 165 the client device 110 receives is optimized. Moreover, the allowed internet traffic 115c is compressed after being whitelisted. For example, one or more public-domain compression algorithms such as gzip may be employed to enhance the speed of content delivery. The gzip file format and software application is used for file compression and decompression, and was developed in the early 90's by Jean-Loup Gailly and Mark Adler as a free software replacement for the compress program used in early Unix systems. The employment of gzip and/or like compression algorithms serves to save the client device 110's bandwidth.

Therefore, all client-based filtering occurs at the proxy servers 125, remote and external from the client device 110. The client device 110, instead of accessing a web application server 135 directly, will have the filtering system 120 act as an intermediary. The client application 123 forces all browser—based internet traffic 115a to the web proxy server(s) 125 of the filter system 120.

One or more users 105 of client devices 110 may attempt to try and bypass the filter system 120 so as to access prohibited websites. Additionally, a malicious “client” may try to bypass the filter system 120 in order to get bad traffic around the whitelist(s) to one or more employees of an organization or children of parent(s). However, the client application 123 has a variety of mechanisms in which to deal with this issue. For example, if the client application 123 knows it is being defeated, it may terminate all browser internet traffic 115a to the client device 110. As such, the client device 110 will be unusable for browsing until the client application 123 reactivates the ability to browse.

In another example, the client application 123 has the ability to rewrite itself so as to prevent being compromised. The client application 123 also is able to hide itself so that is not accessible in the client device 110's settings. In this respect, the client application 123 may be embodied as the aforementioned configuration change file 123, or “file 123”. Reference is made to the '596 patent, which describes a number of roadblocks that may be implemented where the configuration change file 123 essentially comprises a series of group policy or configuration changes as described in this disclosure.

In one example, file 123, embodied as one or more configuration changes on client device 110 may include the ability to turn off system restore at the client device 110 or to hide the client application 123 from an Add/Remove programs list of executable programs in the OS of the user 105's client device 110, and to hide any tray icon for the client application 123 that is displayable on a display of the client device 110 of the user. These features and icons can be simply hid by modifying the client device 110's registry as described in the '596 patent.

Additionally, with the file 123 embodied as one or more configuration changes on client device 110, it may serve to prevent a user 105 of client device 110 from booting from an external source and/or from modifying Basic Input/Output System (BIOS) settings. Namely, and as described in detail in the '596 patent, such prevents the client device 110 from being booted from a CD, USB, or floppy drive is possible by modifying settings in the client device 110's (BIOS). For example, the BIOS boot setting can be prevented from being modified by enabling security in the BIOS and using a secure password. The reason to prevent a malicious user 105 of a client device 110 from booting from any media other than its own hard drive is because it prevents the user 105 from installing a new operating system in an attempt to replace the existing operating system containing the file 123.

Further, selected advanced troubleshooting tools typically available in the OS of the client device 110 may be disabled. As discussed in detail in the '596 patent, one of these tools to be disabled is the Registry Editor (regedit.exe and regedt32.exe, which allow users 105 to perform functions of creating, manipulating, renaming and deleting registry keys, subkeys, values and value data; importing and exporting .REG files, exporting data in the binary hive format; bookmarking user-selected registry keys as Favorites; finding particular strings in key names, value names and value data; and remotely editing the registry on another networked computer.

Another is the command prompt. Disabling cmd.exe, is expected to have minimal impact since it is rarely used in Windows. This could be done since an advanced computer user 105 could use it to run various system tools and commands in an attempt to identify and reverse engineer the steps taken to prevent the user 105 from circumventing, uninstalling or disabling the client application.

Disabling the secpol.msc (local group policy) is another option. Local Group Policy (LGP) (secpol.msc) is a more basic version of the Group Policy used by Active Directory, and in part controls what users 105 can and cannot do on a computer system, for example: to enforce a password complexity policy that prevents users 105 from choosing an overly simple password, to allow or prevent unidentified users 105 from remote computers to connect to a network share, to block access to the Windows Task Manager or to restrict access to certain folders. A group of such configurations is called a Group Policy Object (GPO). The LGP tool is disabled so that an advanced computer user 105 couldn't access LGP and alter or disable the GPOs put in place to prevent the user 105 from compromising the client application 123 downloaded on the client device 110. LGP is also considered non-essential for the client device 110.

Windows Task Manager (taskmgr.exe) could also be disabled, since it provides detailed information about computer performance and running applications, processes and CPU usage, commit charge and memory information, network activity and statistics, logged-in users, and system services. The Task Manager can also be used to set process priorities, processor affinity, forcibly terminate processes, and shut down, restart, hibernate or log off from Windows. Disabling Task Manager prevents any insight and clues being available to the sophisticated computer user 105 as to what may be filtering their internet access.

MSConfig is a system utility to troubleshoot the Microsoft Windows startup process; this troubleshooting tool can disable or re-enable software, device drivers and Windows services that run at startup, or change boot parameters. Since this application could be used as part of an effort to disable or circumvent the client application 123, it can be disabled.

On the Microsoft Windows operating system, the Run command is used to directly open an application or document whose path is known. Thus, it can be disabled to prevent the user 105 from executing or running applications that they may download externally which could help to try and disable and/or circumvent the client application 123 on the client device 110, so as to be able to access illicit websites 130.

Process Monitor is a free tool that monitors and displays in real-time all file system activity on a Microsoft Windows operating system, and also monitors and records all actions attempted against the Microsoft Windows Registry. Process Monitor can be used to detect failed attempts to read and write registry keys. It also allows for filtering on specific keys, processes, process IDs, and values. In addition it shows how applications use files and DLLs, detects some critical errors in system files and more. The launching of this utility tool can be prevented by disabling it, because it can be used by the savvy computer user 105 to help figure out which applications(s) may be running on the client device 110 that are preventing the user 105 from accessing harmful websites. Once they have identified what is doing the blocking, then the user 105 could research how they might be able to circumvent it.

Accordingly, and unlike conventional filtering or content blocking schemes, the effectiveness of the example computer-implemented filtering method and computer system to filter/block content is not dependent on the technical ability of the client, be it a company, organization, parent, or other end user. The example method(s) and system(s) are specially configured to prevent even advanced computer users 105 from disabling and/or circumventing the filter system 120 and/or client application 123 on the client device 110 and/or its functionality contained therein.

The above-described example filtering method and system, in monitoring and filtering the flow of a company or household's Internet traffic, is also able to limit or restrict Internet traffic based on any IP address being utilized. Further, the method as implemented by filter system 120 is able to limit or restrict Internet traffic based on a geographic region, i.e., preventing access to Internet traffic generated from one or more countries not on the whitelist.

Today, a lot of technology is driven by client-side software; this slows computer performance. Unlike most or all of the conventional content blocking applications commercially available today, which are typically installed and implemented by software on the client-side computing device and hence take up client-side processing power, the example method and system is not implemented utilizing the processing power of the client device. Rather, the above-noted example method and system may be installed as a file (the file representing one of a downloaded application file, downloaded group policy or configuration change file or an installed black box (firewall, router or bridge) on the client's network server) that is controlled by one or more external servers in communication with the client device and/or network server.

Accordingly, the above-described example filtering method and system, among providing other benefits, may substantially enhance the client's ability to conserve bandwidth. In its function as an aggregator of Internet traffic, the example filtering method and system, since it is implemented remotely or separately from the client's devices 110 or network servers, removes a significant burden on client-device processing speed, and more importantly is envisioned to substantially reduce the costs of bandwidth to the client, particularly to those companies and households who have to pay a service provider (i.e., VERIZON®, AT&T®, SPRINT®, etc.) “by the byte”.

Moreover, and consistent with many reliable third-party studies describing the deleterious effect that blocking of internet advertising by a client-side installed content blocking application has on bandwidth availability in the client device, the example method's ability to scrub all third-party advertising (among other bad traffic such as streaming videos, malware, etc.) on a whitelisted website prior to rendering the webpage to the client is expected to substantially increase the available bandwidth in the client device.

The example method and system also greatly enhance the privacy of one's own personal information and identity information/IP address. Many large data aggregators, such as GOOGLE, MICROSOFT, FACEBOOK®, TWITTER®, and the like have the ability to track the private information of a web user. For example, assume that a user 105 logs on to CNN.com (assuming on the whitelist) to read the daily news. A page on CNN.com includes many data aggregator “tracker” buttons on its homepage, e.g., “see us on Facebook, Twitter, etc.” which load code onto the CNN® site that allows the user 105's and/or their client device 110's identity and/or certain actions to be tracked. If this user 105 then goes to WIRED.com from the CNN website, each of these data aggregators now know that the user 105 (or that client device 110) is interested in wired.com. This information may be sold to third-party advertisers.

However, in the example filtering process, the tracking code from all of these data aggregators is scrubbed out of the web page(s) prior to rendering the whitelisted site to the client device 110/user 105. For example, the filtering method can change the requested IP address so that any tracking mechanism is blocked out. This leaves only cookies available for inspection, which can be easily disabled by the user 105 of the client device 110. Coupling the example filtering process with the web user/client device placing their own browser into incognito mode shall render the client device 110 un-trackable to these data aggregators; as they no longer will be able to track the user 105, privacy is substantially enhanced.

Therefore, the example method and system offer the ability for the client, through a subscribed-to service or as an installed mechanism on their network server, to have full granular control of their Internet connectivity. As the example method runs on external proxy servers 125 it is decentralized and therefore out-of-control of the client. Even if installed as a black box on a network server, the client will only have surface control or limited access, even requiring permission to edit the whitelist in order to add new safe websites. This arrangement thus protects the client from themselves.

The present invention, in its various embodiments, configurations, and aspects, includes components, methods, processes, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the example embodiments has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The flowchart and block diagrams in the above-described figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments described herein may be implemented in digital electronic circuitry, or in computer hardware, firmware, software, or in combinations of them. The embodiments can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computer system. A computer program can be deployed to be executed on one computer or on multiple computers at one site or distributed across multiple sites and interconnected by a communication network.

Although the example embodiments may have occasionally described components and functions implemented in the embodiments with reference to one or more particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

It is to be understood that the foregoing description is intended to illustrate and not to limit the scope of the invention, which is defined by the scope of the appended claims. Other embodiments are within the scope of the following claims.

We claim:

1. A computer system configured to filter internet traffic between one or more users and the internet, comprising:
a file configured for installation on one or more corresponding client computing devices of the one or more users, and
one or more remote proxy servers in operative communication with the file and the internet, wherein
the one or more proxy servers are configured to analyze website requests from the client devices against one of an internal whitelist of websites built and maintained by the proxy servers on behalf of a consumer organization, and a master whitelist approved and managed by the organization, and
if a website query for a given client device is determined to be on the whitelist, the one or more proxy servers pass the approved internet traffic to the internet so that the client device receives the website URL and content thereof corresponding to the internet traffic, otherwise the request is blocked and access denied.

2. The system of claim 1, wherein the approved internet traffic is further subject to processing by the proxy servers so that the client device receives one or more rendered web pages absent of any advertising images, videos and embedded malware.

3. The system of claim 1, wherein the approved internet traffic is further compressed to preserve bandwidth of the client device.

4. The system of claim 1, wherein private identity information, IP addresses and information specific to the client device is scrubbed so as to be unavailable to a data aggregator program contained in the approved internet traffic.

5. The system of claim 1, wherein the file is embodied as a configuration change on the client device.

6. The system of claim 1, wherein the configuration change further includes means for turning off system restore on the client device prior to installation of the file thereon.

7. The system of claim 6, wherein the configuration change further includes means for hiding software-related features of the filter system once the file is installed on the client device.

8. The system of claim 6, wherein the configuration change further includes means for preventing booting of the client device from external sources.

9. The system of claim 6, wherein the configuration change further includes means for preventing modifying of BIOS settings of the client device.

10. The system of claim 6, wherein the configuration change further includes means for disabling selected advanced troubleshooting tools in the operating system software of the client device

11. The system of claim 1, wherein the file is embodied as a software application downloaded and installed on the client computing device but controlled by the one or more proxy servers.

12. The system of claim 1, wherein the file is embodied as a device installed on a network server serving the client computing device but controlled by the one or more proxy servers.

13. The system of claim 11, wherein the device is one of a firewall, bridge and router.

14. The system of claim 1, the system further configured to limit or restrict internet traffic based on any IP address being utilized by the client device that is not on the whitelist.

15. The system of claim 1, the system further configured to limit or restrict internet traffic based on a geographic region not on the whitelist that is the source of the internet traffic.

16. In a computer system having a processor, operating system software implemented by the processor and representative of executable code, a method for filtering internet traffic between one or more users and the internet, comprising:
receiving website requests from one or more client devices of the one or more users,
comparing the website in the request against one of an internal whitelist of websites built and maintained by one or more external servers on behalf of a consumer organization, and a master whitelist approved and managed by the organization, and if the website is on the whitelist,
granting, by the one or more external servers access to the internet traffic so that the client device receives the website URL and content thereof, otherwise
blocking access to the requested website.

17. The method of claim 16, further comprising:
processing the approved internet traffic by the proxy servers so that the client device receives one or more rendered web pages absent of any advertising images, videos and embedded malware.

18. The method of claim 16, further comprising:
compressing the approved internet traffic to preserve bandwidth of the client device.

19. The method of claim 16, further comprising:
scrubbing private identity information, IP addresses and information specific to the client device so as to be unavailable to a data aggregator program contained in the approved internet traffic.

20. The method of claim 16, wherein
determining further includes evaluating the query against all IP addresses being utilized by the client device, and
blocking further includes limiting or restricting internet traffic based on any IP address being utilized by the client device that is not on the whitelist.

21. The method of claim 20, wherein
determining further includes evaluating the query against all geographical regions on the whitelist, and
blocking further includes limiting or restricting internet traffic to the client device from any geographic region not on the whitelist.
